(19) United States
(12) Patent Application Publication
(10) Pub. No.: US 2020/0027335 A1
(43) Pub. Date: Jan. 23, 2020

(54) Emergency Monitoring and Information System

(71) Applicants: Rajesh Shankar Joshi, Irvine, CA (US); Meghana Rajesh Joshi, Irvine, CA (US)

(72) Inventors: Rajesh Shankar Joshi, Irvine, CA (US); Meghana Rajesh Joshi, Irvine, CA (US)

(21) Appl. No.: 16/273,577

(22) Filed: Feb. 12, 2019

Related U.S. Application Data
(60) Provisional application No. 62/701,360, filed on Jul. 20, 2018.

(51) Int. Cl. G08B 27/00; G08B 5/22; G08B 7/06

(52) U.S. Cl. CPC G08B 27/001; G08B 7/06; G08B 5/229

(57) ABSTRACT

Aspects of the disclosure include systems and methods for providing information to first responders and/or occupants of a building during an emergency. Such information may include, for example, video information, directional information, and/or real-time updated information which may expedite evacuation, provide first responders with information about the emergency that may be unavailable from outside the building, and/or allow for targeted responses to the emergency.

### BACKGROUND

### Field

Aspects of the present disclosure generally relate to building safety, and more particularly to an emergency monitoring and information system.

### Background

When an emergency, e.g., fire, earthquake, etc., occurs, emergency personnel and/or other first responders typically arrive at the scene without detailed knowledge of the situation they may encounter. In a building fire, for example, the initial concern is whether people are trapped in the building. Because the first responders have no data as to whether the building is occupied or not, this can delay and/or change the response of the emergency personnel.

Further, because emergency personnel have little or no information about the source of the fire and/or other emergency, the emergency personnel must proceed slowly and, possibly, in the wrong direction, because the dangers of the situation are unknown.

For people that may be trapped in a building that is on fire, the occupants may also need assistance in exiting the building. The initial evacuation route may be blocked, which may lead to confusion and/or delays in evacuation.

### SUMMARY

Aspects of the disclosure include systems and methods for providing information to first responders and/or occupants of a building during an emergency. Such information may include, for example, video information, directional information, and/or real-time updated information which may expedite evacuation, provide first responders with information about the emergency that may be unavailable from outside the building, and/or allow for targeted responses to the emergency.

An event alarm device for a structure in accordance with an aspect of the present disclosure comprises at least one detector, at least one alarm, and at least one communications device, coupled to the at least one alarm and the at least detector, in which an when an event triggers the at least one detector, the at least one alarm is activated and the at least one communications device transmits information from the at least one detector to a location external to the structure, in which the information aids, at least in part, in responding to the event.

In such an aspect of the present disclosure, the at least one detector may comprise a camera, the information may comprise a video signal, and the information may aid, at least in part, in evacuating the structure and/or determining where within the structure the event is located.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further purposes and advantages, will be better understood from the following description when considered in connection with the accompanying figures. It is to be expressly understood, however, that each of the figures is provided for the purposes of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an embodiment of a safety system in accordance with an aspect of the present disclosure;

FIG. 2 is a block diagram that illustrates a hardware environment in accordance with an aspect of the present disclosure;

FIG. 3 is a block diagram that illustrates a platform in accordance with an aspect of the present disclosure; and

FIG. 4 is a block diagram that illustrates a safety method in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

### Overview

The present disclosure describes a system and method for providing additional information to building occupants and/or first responders when an emergency situation occurs. When a fire, earthquake, natural gas leak, etc. occurs, first responders need information about what is going on inside the building in question. The present disclosure describes an audio-visual system that provides real-time data to first responders and/or building occupants to help in evacuation and/or emergency response approaches.

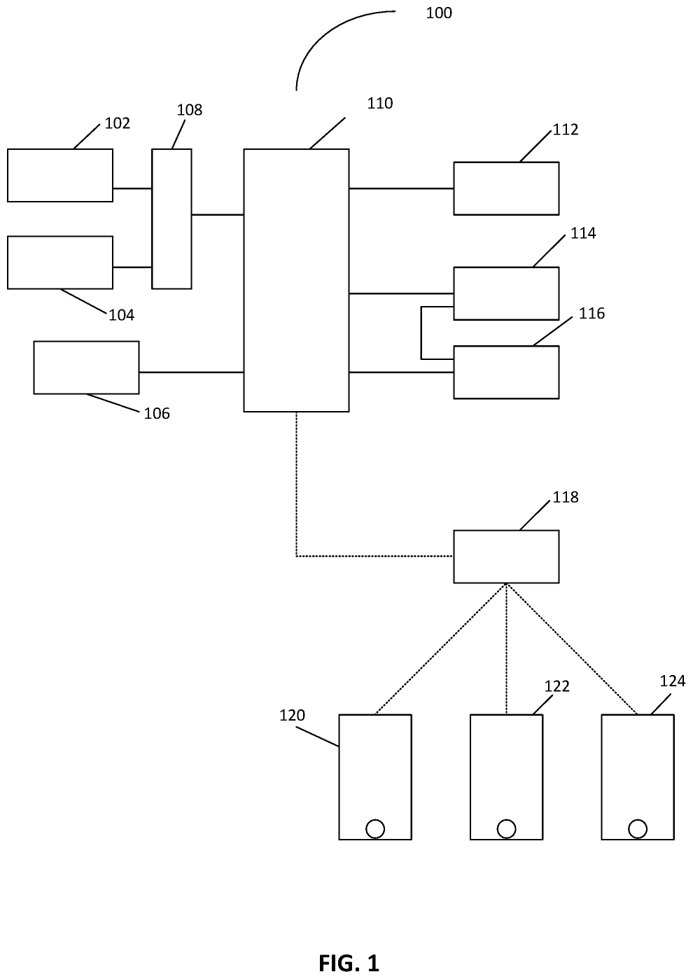

FIG. 1 illustrates an embodiment of a safety system in accordance with an aspect of the present disclosure.

As shown in FIG. 1, system 100 may include a gas sensor 102, a smoke detector 104, a power supply 106, an input interface 108, a processor 110, an alarm 112, a delay circuit 114, a camera 116, and a communications platform 118. System 100 may send data to, and/or receive data from, other devices, such as devices 120, 122, and/or 124, via communications platform 118. Devices 120-124 may or may not be included in system 100 depending on the structure and/or characteristics of system 100.

Gas sensor 102 may sense the presence of carbon monoxide, methane, and/or other gasses that may trigger an alert from system 100. Upon gas sensor 102 sensing above a threshold amount of gas and/or other event, gas sensor 102 may send a signal to processor 110 to indicate the presence of an emergency situation to processor 110.

Smoke detector 104 may sense the presence of smoke and/or other contaminants, and/or other indications of an emergency event that may trigger an alert from system 100. Similar to home-based smoke detectors, smoke detector 104 may send a signal to processor 110 to activate alarm 112; however, a detection signal from smoke detector 104 and/or gas sensor 102 may also trigger other remedial events within system 100.

Gas sensor 102 and/or smoke detector 104 may be included in system 100 along with other sensors that are provided to input interface 108. Such inputs to system 100 through input interface 108, or directly to processor 110, may include but are not limited to a gas detector, a smoke detector, a sprinkler, an actuator, a seismograph, one or more motion sensors, a temperature sensor, a fire sensor, a flame sensor, other types of sensors, and/or any combination thereof. The one or more detectors may detect an occurrence of a trigger. A trigger may include, but is not limited to, a fire, a theft, a natural gas leak, an earthquake, and/or any combination thereof.

Power supply 106 provides power to system 100. Although shown as providing power to processor 110, power supply 106 may provide power to other components within system 100 as desired without departing from the scope of the present disclosure. Power supply 106 may be a direct current (DC) power supply such as a battery, an alternating current (AC) power supply such as power from the outlets, and/or a battery-backup AC power supply, such that system 100 may run on either AC and/or DC power depending on whether power to the building or other structure is present.

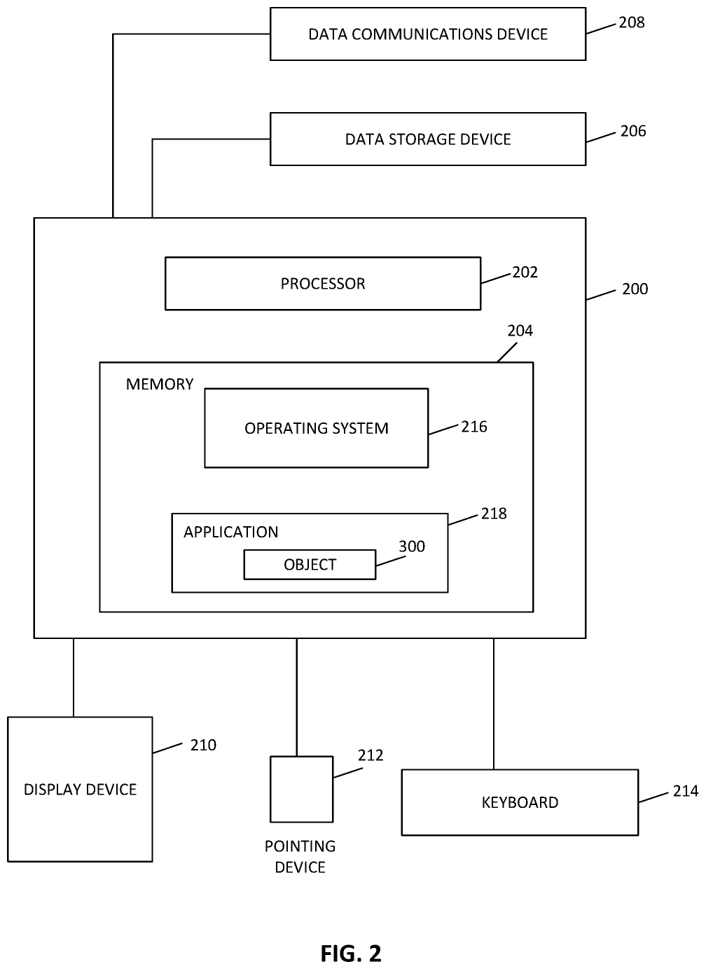

Processor 110 controls the actions of system 100, and is described in further detail with respect to FIG. 2. Processor 110 may receive a signal from the one or more detectors via input interface 108 or directly, when the trigger occurs. Processor 110 may send a signal to the camera 116 such that the camera 116 may capture one or more visual and/or audio recordings to indicate the activities near camera 116. Processor 110 may also send this and/or other data to communications platform 118 for forwarding to various devices 120-124.

Processor 110 may also provide a time stamp, geolocation, and/or other data to indicate the location of camera 116 and/or system 100. As a number of systems 100 may be interconnected, the location of the particular system 100 that is sending data to the devices 120-124 is important, as well as the time stamp for showing progress of the emergency within the building, people trapped or traversing the camera 116 field of view, etc.

Alarm 112 may be a buzzer, horn, and/or other audio-visual signal to indicate to the building occupants that system 100 has detected an emergency situation. Alarm 112 may also be an indicator to an outside agency, e.g., fire department, police department, etc., that system 100 has detected an emergency situation. Depending on the emergency situation that system 100 has detected, different sounds, visual clues, and/or indications to outside agencies may be performed. For example, and not by way of limitation, if smoke detector 102 is providing the input to processor 110, system 100 may have alarm 112 sound a horn and contact the local fire department; if gas detector 104 detects the presence of methane gas, system 100 may provide a beeping sound and contact paramedic services and/or the natural gas provider to the building.

Delay circuit 114 is coupled to camera 116 such that when the proper trigger is received by processor 110, delay circuit 114 may delay the triggering of camera 116 if desired. Camera 116, once activated by system 100, captures visual and/or audio signals from the location of camera 116, and transmits these signals to processor 110.

Communications platform 118 is the interface between processor 110 and other devices 120-122. Communications platform 118 may couple system 100 to other systems 100 within a building, to first responders, to certain personnel within the building that system 100 is installed in (managers, administrative staff, etc.), and/or other devices to help coordinate response to the emergency that has been detected by system 100.

As shown in FIG. 1, communications platform 118 may include, but is not limited to, an internet of things, one or more electronic devices, one or more wearable devices, one or more computers, one or more tablets, one or more displays, and/or any combination thereof. The displays may be configured to display one or more visual depictions from camera 116, data relating to the one or more visual depictions, data from sensors 102 and/or 104, other data sensed by system 100, location of system 100, and/or other data or any combination thereof.

Processor 110 may communicate with communications platform 118 via a wireless and/or hardwired connection including, but not limited to, a Bluetooth connection, an internet connection, a network connection, a cellular connection, and/or any combination thereof.

### Hardware Environment

FIG. 2 is an exemplary hardware environment used to implement an aspect of the present disclosure.

The present disclosure may be implemented using a computer 200, which generally includes, inter alia, a processor 202, random access memory (RAM) 204, data storage devices 206 (e.g., hard, floppy, and/or CD-ROM disk drives, etc.), data communications devices 208 (e.g., modems, network interfaces, etc.), monitor 210 (e.g., CRT, LCD display, etc.), mouse pointing device 212 and keyboard 214. It is envisioned that attached to the computer 200 may be other devices such as read only memory (ROM), a video card, bus interface, printers, etc. Those skilled in the art will recognize that any combination of the above components, or any number of different components, peripherals, and other devices, may be used with the computer 200.

The computer 200 usually operates under the control of an operating system 216. The present invention is usually implemented in one or more application programs 218 that operate under the control of the operating system 216. The application program 218 is usually a CAD program or other graphics program. In the preferred embodiment, the application program 218 provides one or more objects 300.

Generally, the application program 218 and objects 300 comprise instructions and/or data that are embodied in or retrievable from a computer-readable device, medium, or carrier, e.g., the data storage device 206, a remote device coupled to the computer 200 via the data communications device 208, etc. Moreover, these instructions and/or data, when read, executed, and/or interpreted by the computer 200 cause the computer 200 to perform the steps necessary to implement and/or use the present disclosure.

Thus, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope of the present disclosure.

Those skilled in the art will recognize that any combination of the above components, or any number of different components, including computer programs, peripherals, and other devices, may be used to implement the present disclosure, so long as similar functions are performed thereby.

In the present disclosure, a processor, microprocessor, and/or computer may be employed in one or more aspects of the disclosure. The use of a processor, microprocessor, and/or computer in and of itself does not render such aspects of the present disclosure as being directed to a judicial exception to patent-eligible subject matter, i.e., a law of nature, a natural phenomenon, or an abstract idea without significantly more. Further, aspects of the present disclosure may claim patent-eligible applications of the concepts of laws of nature, natural phenomena, and abstract ideas.

For example, and not by way of limitation, the present disclosure is directed toward a patent-eligible concept. Aspects and embodiments of the present disclosure, when taken individually and as an ordered combination, are to be considered when determining whether the additional element(s) transform the nature of the claim.

The present application comprises something more than organizing human activity, either through the use of a processor, microprocessor, and/or computer, and/or otherwise, because the processor does not organize human activity; the processor in aspects of the present disclosure provides data to first responders, people in the building, etc., such that a more informed choice of responding to the emergency can be achieved. Such a result has not been available prior to the present disclosure.

Even if the present disclosure may be directed to a patent-ineligible concept, the elements of the present disclosure, both individually and as an ordered combination, are to be considered to determine whether the additional elements transform the nature of the claim into a patent eligible application. The present disclosure comprises an inventive concept sufficient to ensure that the disclosure in practice amounts to significantly more than a patent upon an ineligible concept. Because the judicial exceptions to patent protection of abstract ideas must be construed carefully, applications of such concepts to a new and useful end remain eligible for patent protection within the present disclosure.

Even if in some instances the present disclosure describes concepts that may be directed to an abstract idea and/or another judicial exception, the present disclosure still describes patentable subject matter that remains eligible for patent protection. For example, and not by way of limitation, the present disclosure does not merely apply applicable laws that are well known in the related art.

Further, the present disclosure describes additional patent-eligible concepts such as a process designed to solve a technological problem in conventional industry practice, and a problem that the industries involved had not been able to obtain previously. Further, the present disclosure is not simply steps previously known and merely implemented on a computer, but feature improvements on an existing technological process. The present disclosure provides solutions and improvements on existing processes that were not previously available.

Because a computer, processor, and/or microprocessor can serve as a patent-eligible structure for a computer-implemented function when the claimed function is coextensive with the microprocessor itself, and a standard microprocessor can serve as sufficient structure for functions that can be achieved by any general purpose computer without special programming, the present invention provides such patent eligibility.

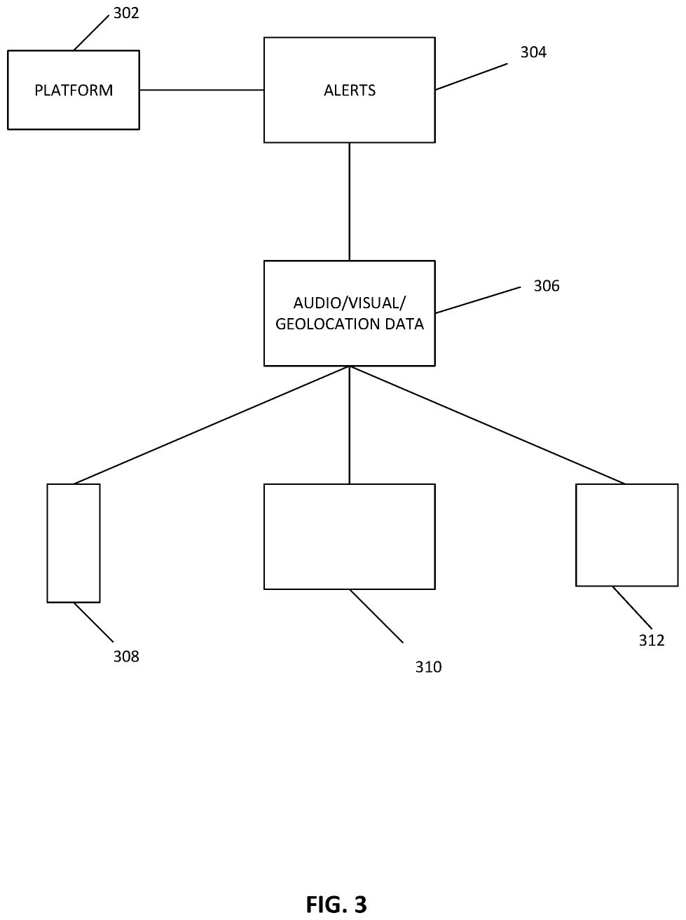

FIG. 3 is a block diagram that illustrates a platform in accordance with an aspect of the present disclosure.

As shown in FIG. 3, platform 302, which may be an embodiment of system 100, may trigger alerts 304. Depending on the alert that is triggered by platform 302, data 306 may be forwarded to one or more devices 308-312.

The one or more devices 308-312 may include one or more electronic devices, one or more wearable devices, one or more computers, one or more handheld devices, and/or any combination thereof. The one or more devices 308-312 may also include one or more displays. The one or more displays may be configured to display the one or more visual depictions, data relating to the one or more visual depictions, the environment data, and/or any combination thereof.

The one or more devices 308-312 may also be configured to operate the platform 302. For example, once an alert 304 is received at a given device 308-312, that device 308-312 may send data, commands, etc., to platform 302 to provide additional data to the device. The platform 302 may generate an alert and also sending one or more visual depictions, data relating to the one or more visual depictions, the environment data, and/or any combination thereof. The alert may include the one or more visual depictions, data relating to the one or more visual depictions, the environment data, and/or any combination thereof.

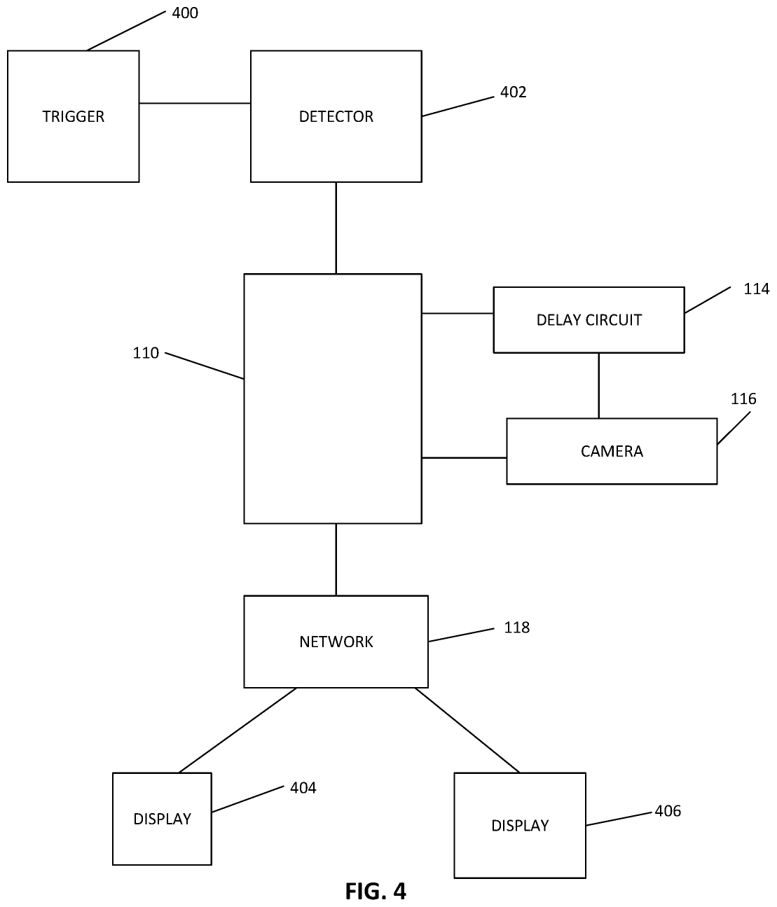

FIG. 4 is a block diagram that illustrates an embodiment of method in accordance with an aspect of the present disclosure. The method may include system 100 as described in FIG. 1.

A trigger event 400 may occur. A detector 402 may detect the trigger event 400. The processor 110 may receive a signal from the detector 402 when the trigger event 400 is detected. The processor 110 may send a signal to the camera 116 through the delay circuit 114 such that the camera 116 may capture one or more visual depictions. The processor 110 may receive the one or more visual depictions and/or data relating to the one or more visual depictions from the camera 116. The processor 110 may receive one or more environment data points from the detector 402. The processor 110 may send the one or more visual depictions, data relating to the one or more visual depictions, the environment data, and/or any combination thereof to the communications platform 118.

The communications platform 118 may include one or more displays 404, 406 that display the one or more visual depictions. One or more persons may view the one or more displays 404, 406. The one or more visual depictions may provide the persons viewing displays 404, 406 with additional information regarding the trigger event 400 and one or more conditions of a field of vision of the camera 116.

In an embodiment, the persons may use the additional information and/or one or more conditions in order to prepare for a response to the trigger event. Further, in any aspect of the present disclosure, the processor 110 may also transmit data relating to the one or more visual depictions. Such data may include, but is not limited to, a location of the imaging component, a time the visual depiction was captured, a date the visual depiction was captured, and/or any combination thereof. The processor 110 may also transmit environment data from the one or more detectors. The environment data may include, but is not limited to, a temperature, a presence of smoke, a presence of fire, other environmental data, and/or any combination thereof. The processor 110 may also be programmed with a floorplan of a building the camera 116 is located in and store the location of camera 116. The processor 110 may also superimpose the one or more visual depictions on the floorplan based on the location of the camera 116 to create a superimposed image. The processor 110 may also transmit the superimposed image.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a view of the device as shown in the present disclosure. Of course, if the device is inverted, above becomes below, and vice versa. Additionally, if oriented sideways, above and below may refer to sides of a device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, and algorithm steps described in connection with the disclosure herein may be implemented as various different types of materials and/or various different combinations of materials. To clearly illustrate this interchangeability, various illustrative components, blocks, modules, and steps have been described above generally in terms of their functionality. The various materials and/or combinations of materials employed to implement the present disclosure depends upon the particular application and design constraints imposed on the overall system. Skilled artisans may implement the described functionality in varying ways for each particular application, but such implementation decisions should not be interpreted as causing a departure from the scope of the present disclosure.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. An event alarm device for a structure, comprising:
at least one detector;
at least one alarm; and
at least one communications device, coupled to the at least one alarm and the at least detector, in which an when an event triggers the at least one detector, the at least one alarm is activated and the at least one communications device transmits information from the at least one detector to a location external to the structure, in which the information aids, at least in part, in responding to the event.

2. The event alarm device of claim 1, in which the at least one detector comprises a camera.

3. The event alarm device of claim 2, in which the information comprises a video signal.

4. The event alarm device of claim 3, in which the information aids, at least in part, in evacuating the structure.

5. The event alarm device of claim 3, in which the information aids, at least in part, in determining where within the structure the event is located.
